(19) United States
(12) Patent Application Publication
(10) Pub. No.: US 2007/0050075 A1
(43) Pub. Date: Mar. 1, 2007

(54) Automatic wafer tracking process and apparatus for carrying out the process

(75) Inventors: Jay Johnson, Portland, OR (US); Sean M. Phillips, Tigard, OR (US)

Correspondence Address: YOUNG & BASILE, P.C., 3001 WEST BIG BEAVER ROAD, SUITE 624, TROY, MI, 48084, US

(73) Assignee: Electro Scientific Industries, Inc., Portland, OR (US)

(21) Appl. No.: 11/213,103

(22) Filed: Aug. 26, 2005

(51) Int. Cl. G06F 19/00

(52) U.S. Cl. 700/121; 700/116; 700/115

(57) ABSTRACT

A semi-conductor wafer processing information system which includes a sensor responsive to the presence of a wafer at a monitored location of a processing machine to read the wafer identification scribe and send both wafer and machine identification signals to a host computer which may be independent of a wafer tracking system. The computer determines whether processing at the selected machine is appropriate. Wafer history information is updated when the wafer departs a given machine.

### FIELD OF THE INVENTION

This invention relates to the processing of semi-conductor wafers and more particularly to an autonomous wafer process information communication system which can be used alone or in cooperation with a wafer tracking system.

### BACKGROUND OF THE INVENTION

Semi-conductor devices are typically manufactured in large numbers on wafers which are taken in batches to processing stations, hereinafter called “machines”, where unique processing steps are carried out. The machines are typically not arranged serially as if in an assembly line and may not even be co-located. To help make sure that wafers do not omit or miss necessary process steps and/or are not subjected twice to the same process steps, the individual machines are often equipped with tracking technology including hardware, software, and system interfaces. Individual wafers are “scribed” with unique identification codes in one of several available forms, including two dimensional identification (2DID), optical characters and bar codes.

Tracking technology of the type described above is well developed and in common use. Many machines, particularly older machines, are not equipped to interface with tracking technology. To accommodate such machines, it is necessary to sort batches of wafers to individually identify those wafers or batches of wafers which are eligible for the processing step or steps carried out at a given machine.

Even in systems where all of the various machines are compatible with tracking technology, it remains necessary for individual machines to generate “read commands” to read the indicia from individual wafers. The wafer indicia is thereafter processed to determine the eligibility of such wafer for the processing steps at a particular machine.

### SUMMARY OF THE INVENTION

The principal object of the present invention is to provide an autonomous wafer processing information control system which can be used with all wafer processing machines including those machines which are not compatible with tracking technology, which can be used in combination with tracking technology where desired, and wherein it is unnecessary for a machine system computer to generate read commands.

According to one aspect of the invention, a method of processing semi-conductor wafers carrying identification indicia is provided. In accordance with the method, each machine among a plurality of processing machines is assigned a discrete identification. A sensor is provided for each machine to sense a wafer presence at a monitored location; e.g., within the field of view of a camera/lighting unit. Wafer identification indicia is then conveyed along with the machine identification to a factory host computer where process specifications and individual wafer processing history information are stored. From this information, a decision is made as to whether the wafer is eligible for processing at the particular machine. In the preferred form, additional information is conveyed to the factory host computer to update the individual wafer processing history as the wafer departs the machine. As hereinafter described, this step can be triggered by an independent departure location sensor or by the arrival sensor as it loses the individual wafer indicia.

The sensor can be located in any of several places; e.g., external to the machine or internal of the machine. One example of an external sensor is a photo detector. An example of an internal sensor is a camera/lighting unit.

According to another aspect of the invention, an autonomous wafer processing control system is provided for a plurality of wafer processing machines, some of which may be equipped with tracking technology. In accordance with this aspect of the invention, each machine is assigned an identity and means capable of producing identity information signals. In addition, each machine is equipped with a presence sensor, such as a photo detector or a camera associated with a wafer indicia read function. In either case, the arrival of a wafer at a monitored location in the machine causes individual wafer identity and machine identity information to be conveyed to processing control center such as a factory host computer where wafer processing specifications and wafer processing history information can be stored. At the control center a decision can be made as to whether an individual wafer or batch of wafers is eligible for processing at the particular machine and information is thereafter provided to permit, as appropriate, the wafer process step to be carried out either manually or automatically. Upon departure of a wafer from the machine where its presence was sensed, wafer processing information is conveyed from the machine to the process control center to update the wafer processing history in an appropriate fashion.

Details of the present invention will become apparent to those skilled in the art when the following description of the best mode contemplated for practicing the invention is read in conjunction with the accompanying drawings.

### BRIEF DESCRIPTION OF THE DRAWINGS

FIG. 1 is a block diagram of a wafer process control system incorporating the present invention.

FIG. 2 is a block diagram of a process which can be carried out using the apparatus of FIG. 1.

FIG. 3 is a planned view of a wafer bearing one acceptable form of identification indicia.

### DETAILED DESCRIPTION OF THE ILLUSTRATIVE EMBODIMENT

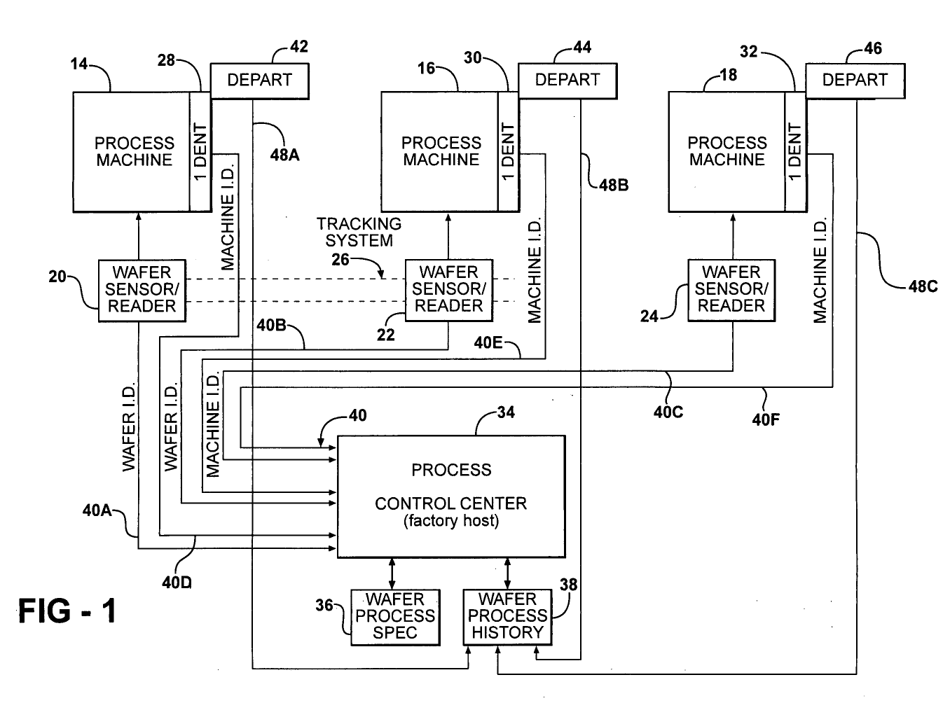

Referring to FIGS. 1 and 3, a system for processing semi-conductor wafers 10 having indicia 12 scribed thereon is shown to comprise individual processing machines 14, 16 and 18, each of which is designed to carry out a different processing step in the overall manufacturing process for the wafers 10. The machines, 14, 16 and 18 are not necessarily serially or sequentially arranged and may be located on different floors or even in different buildings of a “factory”. As will be understood by those skilled in the art, the machines 14, 16 and 18 are capable of receiving wafers 10 in batches created by cassettes or “boats”. Machine 14 further includes a wafer sensor 20 which senses the presence of a wafer 10 at a monitored location relative to the machine 14. The presence sensor may be a simple photo detector capable of responding to specularity or light reflecting qualities of wafers, but is preferably a camera/light unit capable of automatically reading the indicia 12 associated with each wafer 10 as it is presented to the monitored location; i.e., within the field of view of the sensor camera. An example of an optical character recognition system (OCR) suitable for use in the sensor is described in U.S. Pat. No. 5,737,122 issued to D. Wilt and R. Sidell and assigned to Electro Scientific Industries, Inc. of Portland, Oregon. This indicia read operation is carried out without the necessity of a read command generated by a computer associated with the machine 14; i.e., the sensor is in a constant state of readiness for the arrival (and/or departure) of a wafer.

A wafer presence sensor 22 essentially identical to the sensor 20 is associated with the machine 16. A third wafer sensor 24 is associated with the machine 18 and is similar or identical to the sensors 20 and 22.

The machines 14 and 16 are integrated with a tracking system 26 such as the Scribe View™ system available from Electro Scientific Industries, Inc. of Portland, Oreg. In the example of FIG. 1 machine 18 is an older machine not compatible with the tracking system 26 and is not connected thereto.

Machine 14 is equipped with an identity signal generator 28 capable of producing on command a unique machine identifier. Similar identification signal generators 30 and 32 are associated with the machines 16 and 18.

The system of FIG. 1 further comprises a process control center or “factory host” computer 34 having both wafer process specifications and individual wafer process histories stored in memory areas 36 and 38 respectively. The wafer presence sensors 20, 22 and 24 and the machine identification signal generators 28, 30 and 32 are connected by way of inputs 40 through the factory host computer 34 for purposes hereinafter described. Specifically, the wafer identification information produced by the wafer presence sensing cameras 20, 22 and 24 are connected as inputs to the computer 34 by way of lines 40a, 40b and 40c. The identification signals from the machines 14, 16 and 18 are connected to the computer 34 by way of input lines 40d, 40e and 40f. The tracking system 26 is not connected to the host computer 34.

As also shown in FIG. 1 each machine 14, 16 and 18 is equipped with a wafer departure signal generator 42, 44 and 46 respectively. The wafer departure signals from these generators are connected to the computer 34 to update the wafer process histories in memory portion 38. The departure generators 42, 44 and 46 may be set up as discrete equipment components picking up the presence of wafers at monitored departure locations and reading the indicia 12 associated therewith; however, greater efficiency is provided by combining the presence and departure signal information generation in a single camera/light unit. As will be apparent to those skilled in the art, the wafer sensor function is readily carried out by, for example, generating a wafer presence signal immediately upon arrival of a wafer 10 within the field of view of the camera 20 and transmitting the wafer identification information by way of line 40a to the computer 34 as soon as the image in view of the camera sensor 20 stops changing; i.e., indicating that the wafer is at rest. The departure signal 42 is produced on line 48a, for example, when the wafer is no longer present at the monitored location; i.e., the image is no longer stable and/or present indicating that the wafer has either moved on to the processing organs of the machine in preparation for departure or has totally departed the machine, these two approaches being available to the system designer and essentially equivalent.

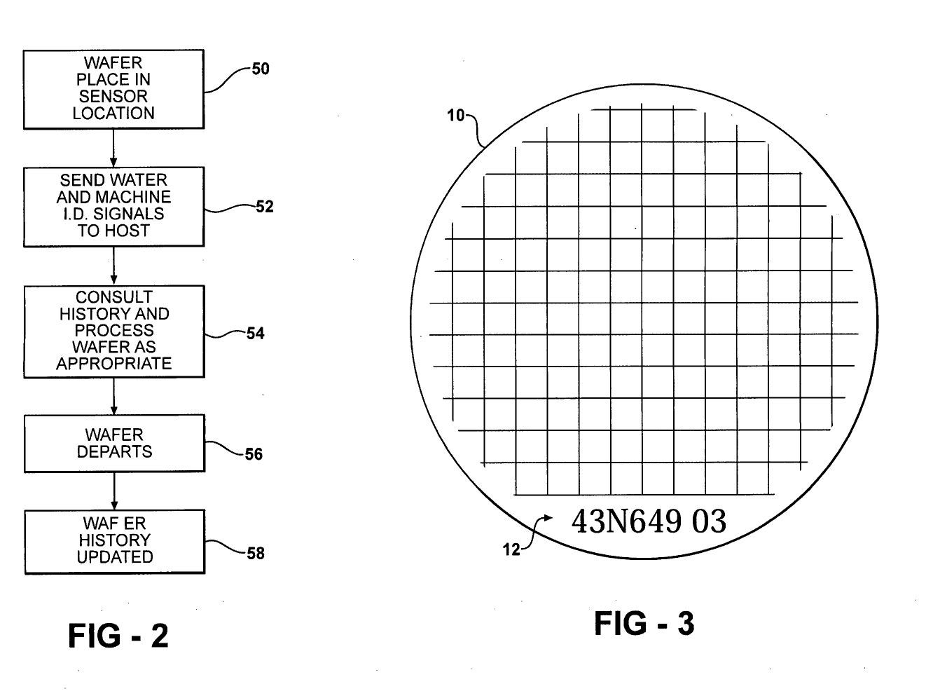

Looking now to FIG. 2, the process of the present invention begins as a wafer 10 is placed in the field of view of one of the sensors 20, 22 and 24. If the sensor is a photo detector, it senses the presence of specular or light scattering material at step 50. If the sensor is a camera/light unit, a changing image indicates the presence of a wafer. When the wafer is sensed and, in the case of a camera/light unit the image stops moving, the wafer and machine identification signals are sent to the host computer 34 at step 52. The processing specification and memory portion 36 and the wafer history information stored in memory 38 are consulted at step 54 and the wafer is processed as appropriate on the basis of resulting information. The wafer departs (step 56) the particular machine and this results in the transmission of information to the computer 34 to update the memory 38 (step 58). From the foregoing it is clear that the autonomous wafer processing information system shown in FIG. 1 can be used with or without a conventional tracking system 26. Where a tracking system is present, system economy suggests that the camera/light unit of the tracking system be used for the functions provided by the sensors 20 and 42, for example, associated with machine 14. These and various other changes and modifications will occur to persons skilled in the art.

What is claimed is:

1. A method of processing semi-conductor wafers carrying identification indicia through a plurality of processing machines with discrete assigned identifications comprising the steps of:
a. sensing the presence of a wafer at a monitored location in one of said machines;
b. reading the indicia of the wafer;
c. conveying the wafer identification and the machine identification to a process control center having processing history information specific to said wafer stored therein; and
d. determining on the basis of the stored information whether it is appropriate to proceed with a processing step at the one machine.

2. The method of claim 1, including the further step of conveying information from the one machine to the process control center to update the processing history information.

3. The method defined in claim 1 wherein the sensing step is carried out by a photo detector.

4. The method of claim 1 wherein the sensing step is carried out by a camera system capable of reading and decoding the indicia.

5. Apparatus for processing semi-conductor wafers carrying identification indicia comprising:
a. a plurality of processing machines each with the capability of producing discrete assigned identification signals;
b. a factory host computer having wafer processing history information stored therein and connected to receive wafer identification indicia and machine identification signals;
c. sensor means associated with each of said machines for sensing the presence of a wafer at a monitored location, and causing the wafer indicia and machine identification signals to be conveyed to said factory host; and
d. means for updating the wafer process history information in the factory host computer upon completion of a processing step at each of said machines.

6. Apparatus as defined in claim 5 wherein the sensor is a photo detector.

7. Apparatus as defined in claim 5 wherein the sensor includes a camera.
